(19) United States
(12) Patent Application Publication
(10) Pub. No.: US 2011/0096847 A1
(43) Pub. Date: Apr. 28, 2011

(54) APPARATUS AND METHOD FOR PARSING BITSTREAM

(75) Inventors: Seung Wook LEE, Daejeon (KR); Bon Ki Koo, Daejeon (KR); Ho Won Kim, Daejeon (KR); Ji Hyung Lee, Daejeon (KR); Euee Seon Jang, Daejeon (KR); Hyungyu Kim, Seoul (KR); Sowon Kim, Seoul (KR); Ming-Xiao Chen, Seoul (KR)

(73) Assignees: Electronics and Telecommunications Research Institute, Daejeon (KR); IUCF-HYU, Seoul (KR)

(21) Appl. No.: 12/909,425

(22) Filed: Oct. 21, 2010

(30) Foreign Application Priority Data
Oct. 22, 2009 (KR) 10-2009-0100649
Sep. 30, 2010 (KR) 10-2010-0095399

(51) Int. Cl. H04L 27/00; H04N 7/24; H04N 7/26

(52) U.S. Cl. 375/240.26; 375/316; 375/E07.003; 375/E07.026

(57) ABSTRACT

Disclosed is an apparatus and method for parsing a bitstream. The apparatus may include an input port analyzer to analyze an input port indicating a source of data in a description, a data receiver to receive the data via the analyzed input port, and a parsing controller to control a parsing process based on the data received via the input port.

### CROSS-REFERENCE TO RELATED APPLICATION

This application claims the priority benefit of Korean Patent Application Nos. 10-2009-0100649, filed on Oct. 22, 2009 and 10-2010-095399, filed on Sep. 30, 2010 in the Korean Intellectual Property Office, the disclosure of which is incorporated herein by reference.

### BACKGROUND

1. Field of the Invention

The present invention relates to an apparatus and method for parsing a bitstream, and more particularly, to an apparatus and method for receiving a bitstream or feedback data of a functional unit in a decoder including at least one functional unit, and parsing the bitstream.

2. Description of the Related Art

Various types of functional units (FUs) may be used for a Motion Picture Experts Group (MPEG) reconfigurable video coding (RVC) standard. Among the FUs, there exists a bitstream syntax parser FU (SynP FU).

The SynP FU has been regarded as a relatively unique functional unit in the conventional standard frameworks since the SynP FU receives a bitstream syntax description (BSD) from an external source instead of an originally programmed functional unit, and is defined as an FU generated based on a content of the BSD.

Accordingly, it has been assumed that only a bitstream can be inputted as an input of the SynP FU. However, in a case of a codec such as a graphics codec where a parsing process and a decoding process are organically connected, there exists a problem that other inputs besides a bitstream are received, and the other inputs are reflected to the parsing process.

Accordingly, there is a need to solve the above problem using the existing SynP FU.

### SUMMARY

An aspect of the present invention provides an apparatus and method for improving a form of reconfigurable video coding (RVC)-bitstream syntax description language (BSDL) to provide an input of a syntax parser FU (SynP FU) by a bitstream syntax description (BSD).

Another aspect of the present invention provides an apparatus and method for performing a parsing process in response to a plurality of outer inputs besides a bitstream.

According to an aspect of the present invention, there is provided an apparatus including an input port analyzer to analyze an input port indicating a source of data in a description, a data receiver to receive the data via the analyzed input port, and a parsing controller to control a parsing process based on the data received via the input port.

According to another aspect of the present invention, there is provided a non-transitory recording where an input port indicating a source of data may be stored in the medium, and a description expressed by a rvc:from attribute may be stored in the input port.

According to still another aspect of the present invention, there is provided an apparatus including a data receiver to receive a bitstream or to receive feedback data from at least one functional unit, via an input port, and a parsing controller to control a parsing process based on the data received via the input port.

According to yet another aspect of the present invention, there is provided a method including receiving a bitstream via an input port, receiving feedback data from at least one functional unit, and controlling a parsing process of the bitstream based on the feedback data received via the input port.

According to an aspect of the present invention, a form of a RVC-BSDL may be improved to provide an input of SynP FU by a BSD.

According to an aspect of the present invention, a parsing process may be performed in response to a plurality of outer inputs besides a bitstream.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an encoder and a decoder according to an embodiment of the present invention;

FIG. 2 is a block diagram illustrating a configuration of the decoder of FIG. 1.

FIG. 3 is a block diagram illustrating a configuration of a parsing unit of FIG. 2.

FIG. 4 is a diagram illustrating an example of a parsing process according to an embodiment of the present invention; and

FIG. 5 is a flowchart illustrating a parsing method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

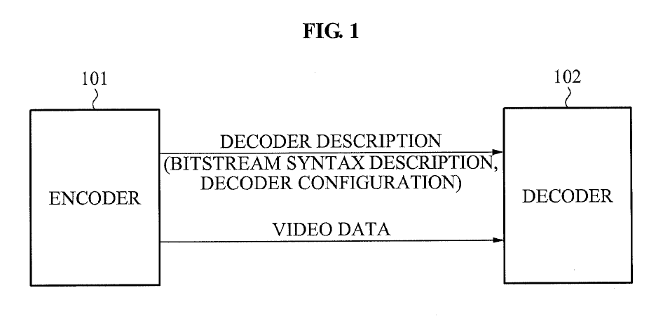

FIG. 1 is a block diagram illustrating an encoder and a decoder according to an embodiment of the present invention.

Here, FIG. 1 illustrates an encoder 101 and a decoder 102 configuring a reconfigurable video coding (RVC) framework. According to the framework of FIG. 1, the encoder 101 may transfer, to the decoder 102, a bitstream including a decoder description and encoded video data. In this instance, the decoder description may define a configuration of the decoder 102 including at least one functional unit. For example, the decoder description may include a bitstream syntax description (BSD) and a decoder configuration indicating a network configuration of the functional units.

The bitstream applied to the present invention may be actualized as a predetermined syntax, and the decoder 102 may include a functional unit providing various coding tools.

The decoder 102 according to the present invention may include a parsing unit that parses the bitstream and at least one functional unit. The parsing unit may receive a bitstream and feedback data of each functional unit. To receive the bitstream and the feedback data, the parsing unit may analyze a bitstream syntax description that defines an input port indicating a source of data. Further details will be described hereinafter.

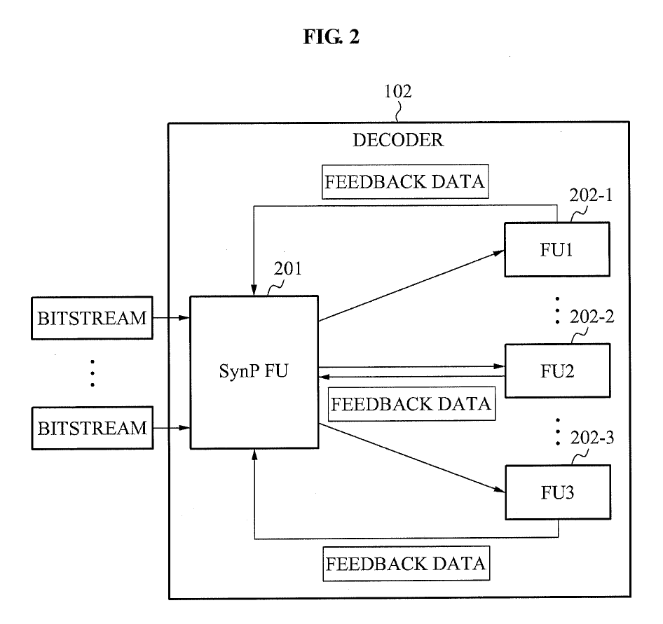

FIG. 2 is a block diagram illustrating a configuration of the decoder of FIG. 1.

Referring to FIG. 2, the decoder 102 may include a parsing unit 201 and at least one functional unit 202-1, 202-3, and 202-3. In FIG. 2, the parsing unit 201 may be indicated by SynP FU, and the functional units 202-1, 202-3, and 202-3 may be indicated by variable length decoder (VLD) FU 1, VLD FU 2, and VLD FU3, respectively.

According to an embodiment, the parsing unit 201 may receive at least one bitstream. Further, the parsing unit 201 may receive feedback data from each of the at least one functional unit 202-1, 202-3, and 202-3.

The parsing unit 201 may analyze an input port indicating a source of data in the BSD included in the bitstream. The parsing unit 201 may analyze an arbitrary input port. To analyze the input port, the BSD may include an attribute instructing the input port. The parsing unit 201 may analyze the attribute defined in the BSD, and may receive data from the input port to control a parsing process based on the analyzed result.

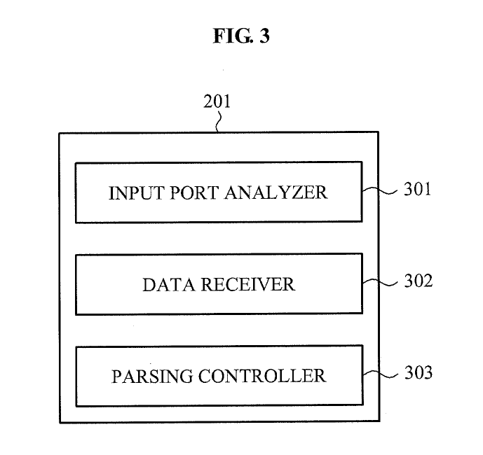

The parsing unit 201 may be further described with reference to FIG. 3.

FIG. 3 is a block diagram illustrating a configuration of the parsing unit of FIG. 2.

Referring to FIG. 3, the parsing unit 201 may include an input port analyzer 301, a data receiver 302, and a parsing controller 303.

The input port analyzer 301 may analyze an input port indicating a source of data in a description. Here, the description corresponds to a BSD included in a bitstream.

For example, the input port analyzer 301 may analyze a description expressed by RVC-BSDL such as eXtensible MarkUp Language (XML) schema. The present invention may not limited to RVC-BSDL, and may include various languages that can express the BSD.

In this instance, the input port analyzer 301 may analyze a rvc:from attribute that instructs the input port in the description. The rvc:from may define the input port that indicates a source of data to be received by the data receiver 302.

For example, the description may include the following sentence.

<xsd:element name=“chroma_format” rvc:from=“bitstream” type=“bs1:b2”/>

Here, the description may indicate that the parsing unit 201 is instructed to read a “chroma_format” bitstream sentence element, in a form of two 1 bits from a “bitstream” input port. The “chroma_format” indicates a bitstream sentence element transferred by the encoder 101.

The description may include the following sentence.

| | | |
|---|---|---|
| <xsd:element | name=“vertex_graph” | rvc:from=“vertex_graph” |
| type=“vertex_graph_type”/> | | |

Here, the description may indicate that the parsing unit 201 is instructed to read the “vertex_graph” feedback data in a form of “vertex_graph_type” from a “vertex_graph” input port. The “vertex_graph” defined in a rvc:from attribute indicates a functional unit. The description may indicate that “vertex_graph” data are feedback data inputted from the “vertex_graph” that is a functional unit. In the description, a kind, a form, a number of data inputted via the input port may be defined.

Thus, according to an embodiment of the present invention, the rvc:from attribute may be defined in the description to express the input port that is a source of data to be received by the parsing unit 201.

The data receiver 302 may receive data via the analyzed input port. Here, data receiver 302 may receive the feedback data of at least one functional unit as well as at least one bitstream. A kind and form of data the data receiver 302 can receive may not be limited.

The data receiver 302 may receive data the input port defined in the rvc:from attribute included in the description. The data receiver 302 may receive not only the bitstream from the encoder 101, but also the feedback data of the functional unit.

The parsing controller 303 may control a parsing process based on the data received via the input port. The parsing controller 303 may control the parsing process associated with the bitstream of multimedia data based on the feedback data of the functional unit received via the input port. For example, the parsing controller 303 may block an input of the bitstream of the multimedia data or wait for the parsing process, based on the feedback data of the functional unit.

A part of the syntax parsing process may require the data be inputted from an external source. In this case, the parsing controller 303 may temporarily stop a particular parsing process from being performed before the data required by the particular parsing process are fully transferred. Programming schemes such as semaphore, dataflow model, and the like may be applied.

For example, when the feedback data of a functional unit A is inputted, the parsing controller 303 may block an input of the bitstream until the feedback data of a functional unit B is inputted or a predetermined algorithm is performed in a functional unit C. When feedback data of the functional unit A is inputted, the parsing controller 303 may not perform the parsing process of the inputted bitstream and temporarily stop the parsing process.

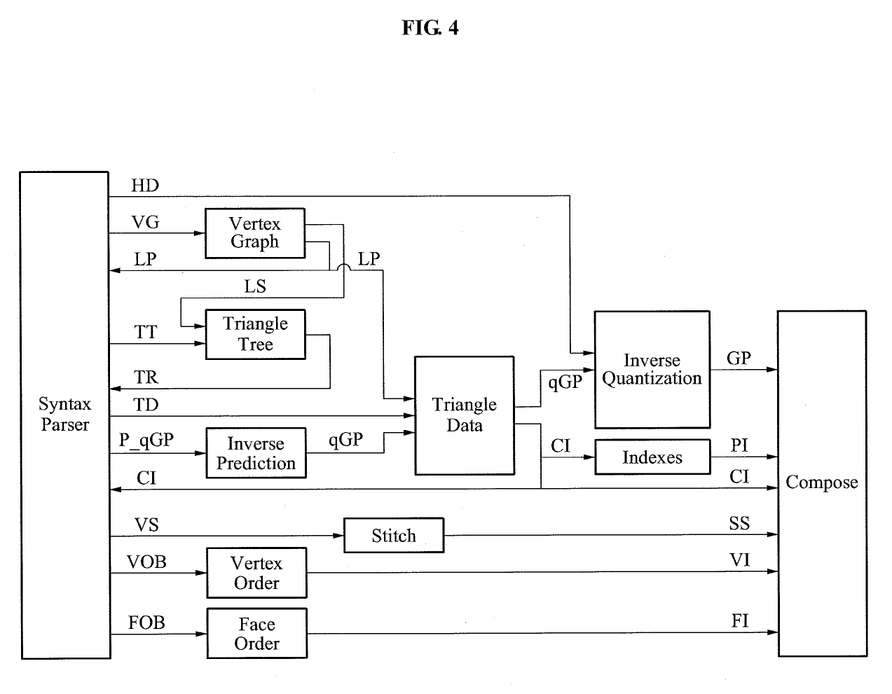

FIG. 4 is a diagram illustrating an example of a parsing process according to an embodiment of the present invention.

A parsing unit (SynP FU) of FIG. 4 may receive feedback data form a plurality of functional units. For example, the parsing unit may receive feedback data LP from a functional unit “Vertex Graph”. The parsing unit may receive feedback data TR from a functional unit “Triangle Tree”, and may receive feedback data CI from a functional unit “Triangle Data”.

The parsing unit may analyze an input port defined in a rvc:from attribute in a description to receive the feedback data form the functional unit. The parsing unit may receive the feedback data and control the parsing process.

For example, it is assumed that the parsing unit may receive the feedback data LP from the functional unit “Vertex Graph” to progress the parsing process for generating TT transferred to the functional unit “Triangle Tree”. The parsing unit may temporarily stop the parsing process associated with the functional unit “Triangle Tree” until receiving the feedback data LP from the functional unit “Vertex Graph”.

Schemes for controlling the parsing process may vary depending on a kind of the functional unit included in a decoder or a kind of data to be decoded.

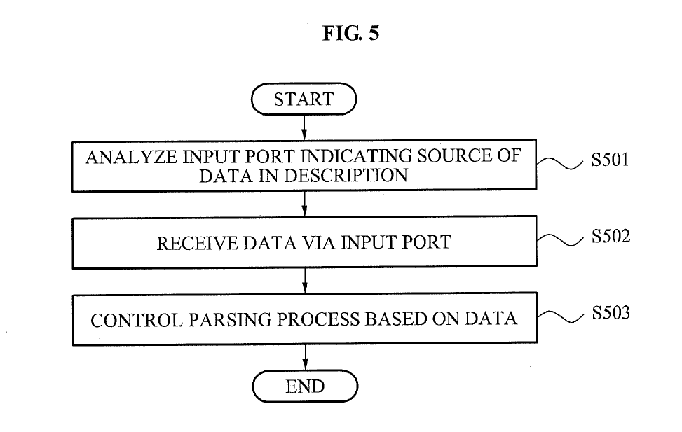

FIG. 5 is a flowchart illustrating a parsing method according to an embodiment of the present invention.

A parsing unit may analyze an input port indicating a source of data in a description in operation S501.

For example, the parsing unit may analyze the description expressed by RVC-BSDL. Here, the parsing unit may analyze the description including a rvc:from attribute that instructs the input port.

The parsing unit may receive the data via the analyzed input port in operation S502. For example, the parsing unit may receive a bitstream of at least one of multimedia data via the input port. The parsing unit may receive feedback data from at least one functional unit via the input port.

The parsing unit may control a parsing process based on the data received via the input port in operation S503. For example, the parsing unit may control the parsing process associated with the bitstream of the multimedia data based on the feedback data of the functional unit received via the input port. The parsing unit may block an input of the bitstream of the multimedia data or wait for the parsing process, based on the feedback data of the functional unit.

The above-described exemplary embodiments of the present invention may be recorded in computer-readable media including program instructions to implement various operations embodied by a computer. The media may also include, alone or in combination with the program instructions, data files, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for receiving and parsing at least one of data, the apparatus comprising:
an input port analyzer to analyze an input port indicating a source of data in a description;
a data receiver to receive the data via the analyzed input port; and
a parsing controller to control a parsing process based on the data received via the input port.

2. The apparatus of claim 1, wherein the data receiver receives a bitstream of at least one of multimedia data via the input port.

3. The apparatus of claim 1, wherein the data receiver receives feedback data from at least one functional unit via the input port.

4. The apparatus of claim 1, wherein the input port analyzer analyzes the description expressed by reconfigurable video coding-bitstream syntax description language (RVC-BSDL).

5. The apparatus of claim 4, wherein the input port analyzer analyzes the description instructing the input port.

6. The apparatus of claim 1, wherein the parsing controller controls the parsing process associated with a bitstream of multimedia data, based on feedback data of a functional unit received via the input port.

7. The apparatus of claim 6, wherein, the parsing controller blocks an input of the bitstream of the multimedia data or waits for the parsing process, based on the feedback data of the functional unit.

8. A method performed by an apparatus for receiving and parsing at least one of data, the method comprising:
analyzing an input port indicating a source of data in a description;
receiving the data via the analyzed input port; and
controlling a parsing process based on the data received via the input port.

9. The method of claim 8, wherein the receiving comprises receiving a bitstream of at least one of multimedia data via the input port.

10. The method of claim 8, wherein the receiving comprises receiving feedback data from at least one functional unit via the input port.

11. The method of claim 8, wherein the analyzing comprises analyzing the description expressed by reconfigurable video coding-bitstream syntax description language (RVC-BSDL).

12. The method of claim 11, wherein the analyzing comprises analyzing the description instructing the input port.

13. The method of claim 8, wherein the controlling comprises controlling the parsing process associated with a bitstream of multimedia data based on feedback data of a functional unit received via the input port.

14. The method of claim 13, wherein the controlling blocks an input of the bitstream of the multimedia data or waits for the parsing process, based on the feedback data of the functional unit.

15. A non-transitory recording medium readable in a computer where an input port indicating a source of data is stored in the medium, and a description instructing the input port is stored in the input port.

16. An apparatus for receiving and parsing at least one of data, the apparatus comprising:
a data receiver to receive a bitstream or to receive feedback data from at least one functional unit, via an input port; and
a parsing controller to control a parsing process based on the data received via the input port.

17. The apparatus of claim 16, wherein the input port indicates a source of data in a description.

18. A method of receiving and parsing at least one of data, comprising:
receiving a bitstream via an input port;
receiving feedback data from at least one functional unit; and
controlling a parsing process of the bitstream based on the feedback data received via the input port.

19. The method of claim 18, wherein the input port indicates a source of data in a description.

20. The method of claim 18, wherein the controlling comprises controlling the parsing process associated with a bitstream of multimedia data based on feedback data of a functional unit received via the input port.
